(19) United States
(12) Patent Application Publication
(10) Pub. No.: US 2010/0328680 A1
(43) Pub. Date: Dec. 30, 2010

(54) OPTICAL SENSOR

(75) Inventors: Holger Moench, Vaals (NL); Johannes Baier, Wuerselen (DE); Mark Carpaij, Aachen (DE); Rainer Hilbig, Aachen (DE); Johanna Sophie Kolb, Aachen (DE); Stefan Schwan, Herzogenrath (DE); Alexander Marc Van Der Lee, Venlo (NL); Ulrich Weichmann, Aachen (DE); Daiyu Hayashi, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/918,829

(22) PCT Filed: Feb. 3, 2009
(86) PCT No.: PCT/IB2009/050433

§ 371 Date: Aug. 23, 2010

(30) Foreign Application Priority Data
Feb. 28, 2008 (EP) 08102107.3

(51) Int. Cl. G01B 11/14

(52) U.S. Cl. 356/615

(57) ABSTRACT

An optical sensor (600) for detecting the movement of an object relative to the position of the optical sensor (600), using self-mixing interference, is described. The optical sensor (600) comprises a laser (100), a detector (200) and a filter device (500). The filter device (500) suppresses measurement signals generated by means of the detector (200) when movements of the object at a velocity below a defined threshold value cause the measurement signals. The optical sensor (600) may be used in a switch in order to enable selective switching depending on the velocity of the movement of the object.

### FIELD OF THE INVENTION

The present invention relates to an optical sensor and a method of detecting the movement of an object relative to the position of the optical sensor. The invention also relates to a switch comprising the optical sensor, and use of a system comprising the optical sensor.

### BACKGROUND OF THE INVENTION

US 2006/0043278 A1 describes a VCSEL pin sensor comprising a vertical cavity surface-emitting laser (VCSEL) operable as a signal emitter, and a silicon photodetector adapted to receive light signals co-mounted in a common canister in which a four-lead header and an insulating ceramic spacer is also containable. The canister can be electrically connected to a first lead from the header. The insulating ceramic spacer is adapted to mount the VCSEL above the level of the photodetector within the canister. The VCSEL is electrically connectable to a second and third lead from the header, and the photodetector is electrically connectable to the second and a fourth lead from the header. Co-packaging of a VCSEL and a photodetector in common-device canisters may yield a contrast ratio of about 20:1 for an object which is present in front of the sensing system. A small pattern, which is necessary for a high accuracy, is provided by the system, while a barrier is not necessary between the emitter and the detector. The VCSEL pin sensor presents the problem that any differentiation between wanted and unwanted sensor signals provided by the VCSEL pin sensor is not possible. Every object within the range of detection of the VCSEL pin sensor may cause a sensor signal.

### OBJECT AND SUMMARY OF THE INVENTION

It is an object of the present invention to provide an improved optical sensor.

The object is achieved by means of an optical sensor for detecting the movement of an object relative to the position of the optical sensor, the optical sensor comprising at least one laser, at least one detector and at least one filter device, the laser having a laser cavity for generating a measuring beam and illuminating the object therewith, wherein at least some of the measuring beam radiation reflected by the object re-enters the laser cavity and causes interference of the reflected measuring beam radiation and the optical wave in the laser cavity, which interference of the reflected measuring beam radiation and the optical wave is influenced by the velocity of the movement of the object, the detector being adapted to sense the interference of the reflected measuring beam radiation and the optical wave and being further adapted to generate a corresponding measurement signal, and the filter device is adapted to suppress measurement signals caused by movements of the object at a velocity below a defined threshold value.

The laser may be a solid-state laser diode, which may be a Side-Emitter, a Vertical Cavity Surface-Emitting Laser diode (VCSEL) or a Vertical Extended Cavity Surface-Emitting Laser diode (VECSEL). The detector may be, for example, a photodiode well known to those experienced in the art. The interference of the reflected measuring beam radiation and the optical wave in the laser cavity is caused by a Doppler shift between the reflected measuring beam radiation and the optical wave in the laser cavity due to the movement of the object, resulting in a modulation of the optical wave in the laser cavity. The frequency of the modulation of the optical wave in the laser cavity is proportional to the velocity component parallel to the measuring beam. The effect is known to those skilled in the art as Self-Mixing-Interference (SMI). Especially VCSELs or VECSELs allow integration of the photodiode in one device by means of semiconductor processing, resulting in a highly sensitive and compact optical sensor. Details about detection of velocities by means of self-mixing interference and electrical driving schemes of the laser can be found in, for example, WO 02/37410 A1, FIG. 2 to FIG. 7 and the related description. The photodiode may convert the optical signal resulting from the modulation of the optical wave in the laser cavity into an electric measurement signal, and the filter device comprises at least one high-pass filter suppressing all signals resulting from movements parallel to the measuring beam of the object relative to the optical sensor below a defined velocity. Slow motions of, for example, a hand within the range of detection of the optical sensor may cause a modulation of the optical wave in the laser cavity, but the resulting electric signal is filtered by means of the high-pass filter. A specific movement of the hand (e.g. waggling) with a velocity component parallel to the measuring beam above the threshold value of the velocity may cause an electric signal that passes the high-pass filter, and the electric signal may be used, for example, for switching. The high-pass filter may be adjustable in order to define the threshold value in accordance with the specific application. A lower threshold value of a velocity component of an object, e.g. a human hand, parallel to the measurement beam may be 0.05 m/s or more preferably 0.1 m/s.

In another embodiment of the present invention, the filter device is adapted to suppress measurement signals caused by movements of the object at a velocity below a defined lower threshold value and to suppress measurement signals caused by movements of the object at a velocity above a defined higher threshold value. Use of such a filter device or in other words such a bandpass filter allows detection of very specific movements. The resulting electric signals passing the bandpass filter may be used, for example, to trigger an automated process. The filter may also comprise two or a plurality of bandpass filters switched parallel to each other, while the bandpass filters may have different passbands. More than one bandpass filter with different passbands allow detection of different dedicated velocity ranges. The resulting electric signals may be used for switching between a plurality of different states. One example may be the dimming of a lamp by means of different movements of a hand.

Additionally or alternatively, the optical sensor may comprise at least a first and a second laser, a first and a second detector and a first and a second bandpass filter, the first bandpass filter being adapted to suppress measurement signals caused by movements of the object at a velocity below a defined first lower threshold value and to suppress measurement signals caused by movements of the object at a velocity above a defined first higher threshold value, and the second bandpass filter being adapted to suppress measurement signals caused by movements of the object at a velocity below a defined second lower threshold value and to suppress measurement signals caused by movements of the object at a velocity above a defined second higher threshold value. Two, three, four or even an array of lasers with corresponding detectors, for example, an array of VCSELs with attached photodiodes can be used, for example, to confirm the measurement results of the first laser and the first detector if the passbands of the first and, for example, the second bandpass filter overlap or are even identical. This means that, in this case, the electric signals provided by the photodiodes have to pass both bandpass filters in order to trigger a subsequent action (e.g. switching). Alternatively, the bandpass filters may have different passbands, which means that, for example, the first higher threshold value of the first bandpass filter may be lower than the second lower threshold value of the second bandpass filter. This approach can be easily extended to three, four or more lasers, detectors and bandpass filters. Similar to the embodiment with one laser, detector and several bandpass filters switched in parallel, more than one bandpass filter having different passbands in combination with corresponding lasers and detectors allow detection of different dedicated velocity ranges. The resulting electric signals may be used for switching between multitudes of different states. One example may be the dimming of a lamp by means of different movements of a hand.

In a further embodiment of the invention, the optical sensor further comprises an optical device for shaping the measuring beam. The optical device may comprise a lens for focusing the measuring beam and/or a mirror for redirecting the measuring beam. Use of a lens enhances the range of detection of the optical sensor and may limit the volume within the optical sensor, which may be activated to a volume around the focal point of the lens, hereinafter referred to as sensor field. The sensor field may be redirected by means of a mirror. Other examples of optical devices for shaping or manipulating the measuring beam are beam splitters or deflection prisms, which may be used to enhance the range of detection of the optical sensor. Furthermore, the lens and/or the mirror may be controllable. A lens with a variable focus may extend the range of detection of the optical sensor. A moveable mirror may be used to address different sensor fields within a volume. Combining, for example, the moveable mirror with a motor and control electronics for controlling the motor may allow, for example, scanning of a room so as to switch, for example, a light source from different places (door, desk, etc.) in the room. The scanning of different volumes may be synchronized with the switching between different high-pass or bandpass filters so as to allow, for example, dimming of a lamp as described above.

In another embodiment according to the present invention, the optical sensor comprises at least a first laser for generating a first measuring beam and a second laser for generating a second measuring beam, and the optical device is adapted to focus the first measuring beam to a first region in space and is further adapted to focus the second measuring beam to a second region in space. Two, three, four or an array of lasers and corresponding detectors, preferably in combination with an optical device as a lens to focus the different measuring beams, may be used to allow permanent observation of different volumes in a room. The lasers may be directed in different directions, or passive optical devices such as, for example, curved mirrors may be used to redirect the measuring beams of different lasers to different places. A combination of several lasers and detectors and an optical device comprising several passive and active optical devices as controllable mirrors is also possible. The lasers may be activated at the same time by using one driver for one laser or sequentially by using one driver for all or a subset of lasers.

An optical sensor according to invention may be integrated in a switch. The selectivity of the optical sensor enables switches that can be tailored to change the switching state only if an object exhibits a defined movement. Remote switching of devices, such as lamps, stereo equipment, TV-sets and the like may be possible from different places in a room. Security switches may be selective with respect to the velocity of an approaching object (car) and can be combined with security systems in order to prevent dangerous situations.

An optical sensor according to present invention may be used in at least one of the applications chosen from the group of:
lighting control;
medical applications;
automotive applications, and
industrial manufacturing applications.
   Special examples of application are:
An optical sensor used in a proximity switch for lighting applications. A hand moving towards the optical sensor and coming close enough switches the lights on and off.
The same switch may be used for interior lighting in cars. This is especially helpful because it avoids an annoying search for the switch in the dark. Furthermore, a fast movement of the hand in the direction of the interior lamp is rather unambiguous.
Contactless (hygienic) activation or steering of medical devices.
An optical sensor mounted at car doors and giving a signal if the opening door quickly approaches an object (neighboring car in a parking lot). The signal can be used to sound an alarm or even stop the door opening by a kind of brake.
A similar optical sensor can be used as a safety switch in many applications. Car windows, train doors, production equipment, etc. need a sensor if hands, etc. are moving into the space of movement. Compared to mechanical switches, it is an advantage that the moving part does not even touch the hand.
End switches control motorized movements. As these react rather late (after mechanical contact has been made), the described optical sensor allows a less abrupt stop.

It is a further object of the present invention to provide an improved method of detecting movements.

The object is achieved by means of a method of detecting the movement of an object relative to the position of an optical sensor, wherein the optical sensor comprises at least one laser having a laser cavity, at least one detector and at least one filter device being adapted to suppress measurement signals caused by movements of the object at a velocity below a defined threshold value, the method comprising the steps of:
generating a measuring beam in the laser cavity,
illuminating the object with the measuring beam,
reflecting a part of the measuring beam by the object,
re-entering the laser cavity of a part of the reflected measuring beam,
interfering of reflected measuring beam radiation and the optical wave in the laser cavity,
influencing the interference of the reflected measuring beam radiation and the optical wave by the velocity of the movement of the object,
sensing the interference of the reflected measuring beam radiation and the optical wave in the laser cavity by means of the detector,
generating a measurement signal by means of the detector, and
suppressing measurement signals caused by movements of the object at a velocity below a defined threshold value by means of the filter device.
   Suppressing measurement signals to a level below a certain threshold value may be used to tailor the method to different applications.

In a further embodiment of a method according to the invention, the method comprises the additional step of switching a switch if a measurement signal caused by movements of the object at a velocity above the defined threshold value is generated. This method relates to switching applications such as, for example, in lighting control. A measurement signal above the threshold value passes the filter, and a switch is switched from one switching state to another, for example, from on to off.

Additional features, which will be described below, can be mutually combined and combined with any one of the aspects. Other advantages, particularly as compared to other prior art, will be apparent to those skilled in the art. Numerous variations and modifications can be made without departing from the scope of the claims of the present invention. It should therefore be clearly understood that the form of the present invention is illustrative only and is not intended to limit its scope.

### BRIEF DESCRIPTION OF THE DRAWINGS

The present invention will be explained in greater detail with reference to the Figures, in which the same reference signs indicate similar parts, and in which:

FIG. 1 is a schematic view of a VECSEL comprising a VCSEL and an integrated photodiode.

FIG. 2 is a schematic view of a first embodiment of the invention.

FIGS. 3a and 3b are schematic views of different collimating conditions of an optical sensor according to the present invention.

FIG. 4 is a schematic view of a second embodiment of the invention.

FIG. 5 is a schematic view of a third embodiment of the invention.

FIG. 6 is a schematic sketch of an optical sensor according to the invention, used in a control system.

FIG. 7 shows the linear dependence between the velocity of an object parallel to the measurement beam and the frequency of the interference signal in the laser cavity of the laser.

FIG. 8 is a schematic view of a further embodiment of the invention.

### DESCRIPTION OF EMBODIMENTS

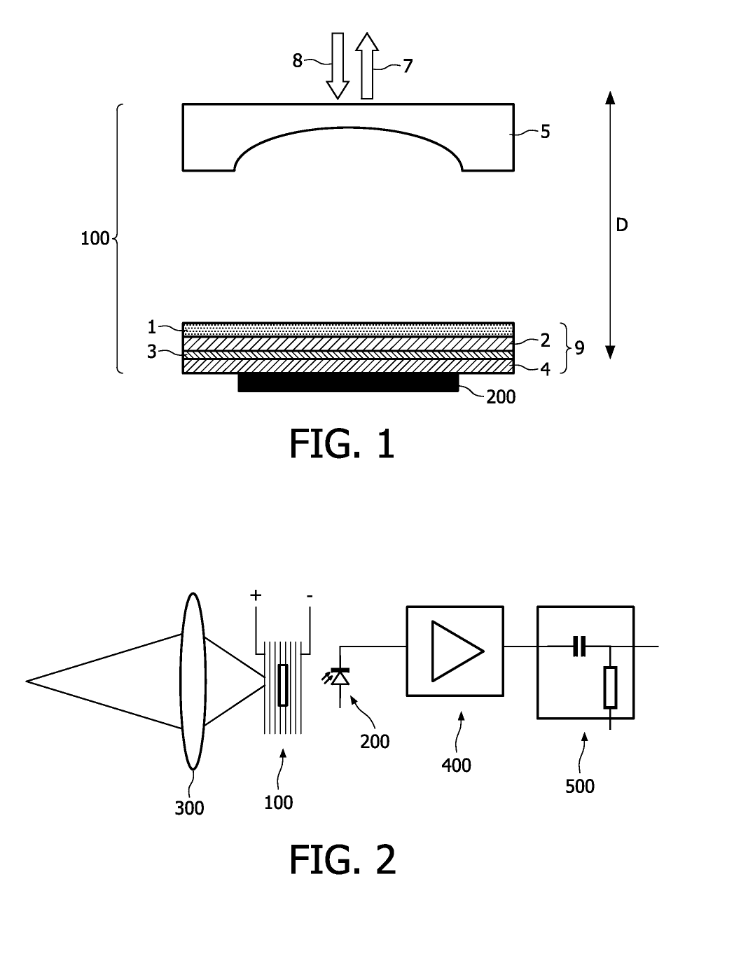

FIG. 1 shows a VECSEL, which may be used as a laser 100, together with an integrated photodiode, which may be used as a detector 200 in an optical sensor according to the present invention. The VECSEL comprises a VCSEL layer structure 9 and is formed by an electrically pumped gain medium 3 (InGaAs quantum wells embedded in GaAs) embedded between two Distributed Bragg Reflectors (DBR) 2, 4, which form an inner cavity of the laser. The lower DBR 4 is highly reflective (reflectivity preferably >99.5%) for the lasing wavelength, while the upper DBR 2 has a smaller reflectivity in order to allow feedback from the external cavity. One of the DBRs is p-doped and the other is n-doped so as to allow efficient current feeding into the gain region. In this example, the lower DBR 4 with the higher reflectivity is p-doped and the upper DBR 2 is n-doped. Principally, however, doping in the reversed order is also possible. The operating current for current injection into the gain medium 3 is provided by an appropriate power source (not shown) connected to a control unit (not shown) for timely modulating the injection current. A frequency shift of the emitted laser radiation 7 for obtaining the desired distance or velocity information is achieved with this current modulation. A suitable current shape is fed into the gain region via the n and p-DBR electric contacts (not shown in the Figure). The photodiode, which is attached to the rear side of the lower DBR 4, measures the small amount of radiation leaking from the highly reflective p-DBR mirror 4 and thus monitors the influence of the backscattered light 8 from the target (not shown in the Figures) on the laser, from which information the distance or velocity of the target object can be extracted. The VCSEL layer structure 9 is grown on an appropriate optically transparent substrate 1. Such a layer structure on this substrate can be produced in a low-cost production process for VCSEL chips. The photodiode is therefore attached to the rear side of such a chip. A laser mirror 5 placed and adjusted at a suitable distance above the upper DBR 2 forms the external cavity. A narrow-band Volume Bragg Grating (VBG) having appropriate IR reflection properties can form this laser mirror 5, for example, by means of a metal or dielectric coated mirror. The gain medium is electrically pumped at a level which does not allow the inner laser cavity system to exceed the laser threshold, but requires feedback of the external cavity, i.e. the external mirror 5, to achieve lasing. In this way, the properties of the emitted laser radiation 7 are determined by the external laser cavity rather than by the short inner cavity on the VCSEL chip. Consequently, also the divergence angle of the emitted laser radiation 7 is decreased and the mode quality is enhanced as compared with a pure VCSEL-based sensor. The laser can thus be better focused on a target object, and the feedback 8 (backscattered radiation from the target object) into the laser cavity, which is required for the sensing application, is improved. Nevertheless, also a simple VCSEL without a mirror 5 can be used as a laser in an optical sensor according to the present invention.

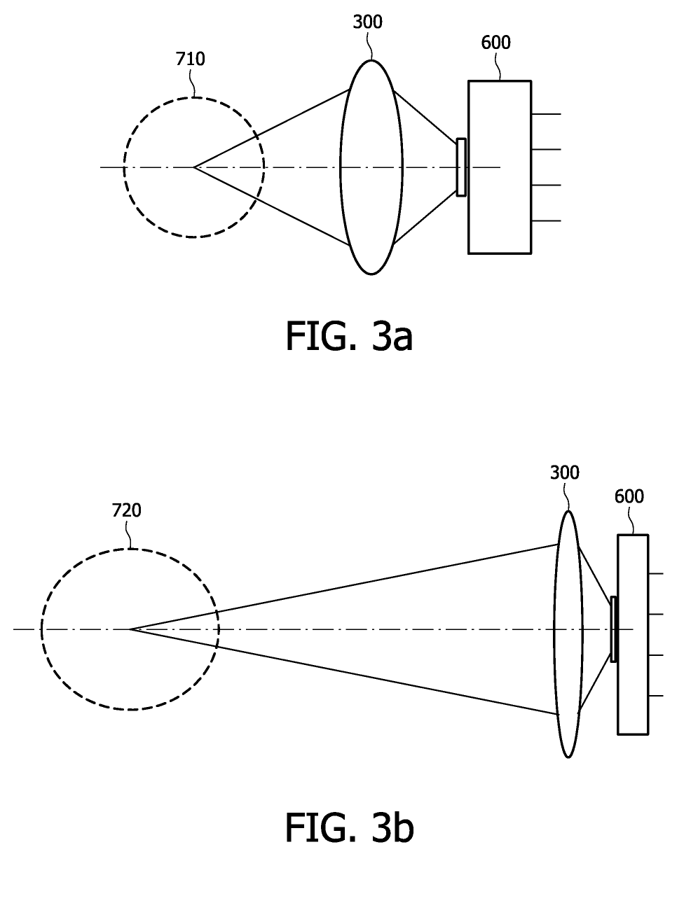

FIG. 2 shows a first embodiment of an optical sensor according to the invention. The optical sensor comprises a laser 100 (a VCSEL), a detector 200 (a photodiode) measuring the output of the VCSEL, an optical device 300 (a collimating lens), an amplifier 400 (optional) and a filter device 500, which is a high-pass filter comprising a resistor and a capacitor. The high-pass filter defines the threshold value for a measurement signal generated by means of the photodiode. The collimating lens is used to focus the beam at a location which represents the desired space of highest sensitivity. As is shown in FIGS. 3a and 3b, the distance between the space of highest sensitivity and the optical sensor 600 can be determined by the degree of focusing (numerical aperture). In FIG. 3a, the measuring beam of the VCSEL is focused near the optical sensor, resulting in a sensor field 710, whereas in FIG. 3b, the measuring beam of the VCSEL is focused farther away from the optical sensor, resulting in a sensor field 720. Alternatively, a combination of two or more lenses may be used, for example, one for collimating and one for focusing (not shown). The optical sensor 600 comprises the laser, the detector and the filter device and optionally further electronics for evaluation of the measurement signal generated by the detector.

The optical sensor may have the additional feature that the sensor selects the position of the sensor field by self-adjusting depending on the demands within the application.

As stated above an adaptable optics, for example,
a lens with variable distance to the VCSEL (e.g. with help of piezo drive)
a tilted lens
a lens from flexible material with a measure to deformation
a lens based on liquid crystal kind of materials
a system of lenses with different foal areas and a rotating/sweeping mirror may be used to manipulate the spatial position of the sensor field
   The sensor field may be swept the whole time by using, for example, a saw tooth voltage to drive the adaptable optics. During the same time, the optical sensor may detect the movement of an object with a velocity component parallel to the measurement beam above a defined threshold value as discussed above. Therefore, a specific movement of for example a hand (e.g. waggling) with a velocity component parallel to the measuring beam above the defined threshold value will be detected within the area that is covered by the position of the sensor field over time. The spatial sensitivity (for example, position of waggling hand relative to optical sensor) is less critical for using the optical sensor as a switch because the optical sensor is measuring at least part of the time in the region of highest sensitivity. For this reason the optical sensor may be more robust.

In alternative embodiment the optical sensor 600 may be used to measure all movements (not only specific ones) in addition. This can be realized, for example, by sweeping the sensor field the whole time by using, for example, a saw tooth voltage to drive an adaptable optics and using directly the output signal of the amplifier 400 or by using a very broadband filter device in parallel to the filter device depicted in FIG. 2 (used to detect a movement of an object with a velocity component parallel to the measurement beam above a defined threshold value) to generate an additional signal as a kind of trigger voltage UTr. The detection of all movements may be used to optimize the spatial position of the sensor field in a first step. If, for example, a sudden movement is detected i.e. trigger voltage UTr passes an offset value and the sweeping of the sensor field may be stopped. Therefore, the sensor field is adjusted by means of an adaptable optic to the spatial position where a specific movement (i.e.: waggling hand) eventually just takes place. Sweeping of the sensor field may be stopped as long as a specific signal is detected (by the normal operation mode of the optical sensor, these signals are got in parallel to the trigger voltage UTr all the time). If no specific signals may be measured via the filter device 500 (no movement of an object with a velocity component parallel to the measurement beam above a defined threshold value) at this spatial position of the sensor field (the sudden movement was, for example, a walking person) sweeping of the sensor field may start again. The time interval between stopping the sweep and starting may be given by an internally determined delay time (for example: tdel=0.1 s). This delay time tdel can be realized, for example, by using a RC-element triggered by “zero voltage level” at the measuring output of the optical sensor (output of high pass 500 in FIG. 2). The signal level may be close to the maximum value that can be achieved due to stopping the sweep during measuring specific movements together with the well positioned sensor field. The latter may increase the response time of the optical sensor.

As continuous sweeping of the lens system might come up with some unwanted energy consumption the sensor field may only be swept during that time when a specific movement is detected. As discussed above the optical sensor may be used to measure nearly all movements by means of an additional broadband filter device in parallel to filter device 500 shown in FIG. 2. The starting situation may be the following: The sensor field of the optical sensor is positioned at position zo using a bias voltage of Uo to position the adaptable optics. If the optical sensor detects a movement (specific or unspecific) the adaptive optics starts wobbling the sensor field around zo (preferably starting with small shifts of the focus) to optimize the position of the sensor field by using the amplitude of the voltage UT. In parallel, the optical sensor is operated independently in the detection modus to detect movements with a velocity component parallel to the measuring beam above a defined threshold value.

Now different situations are possible:

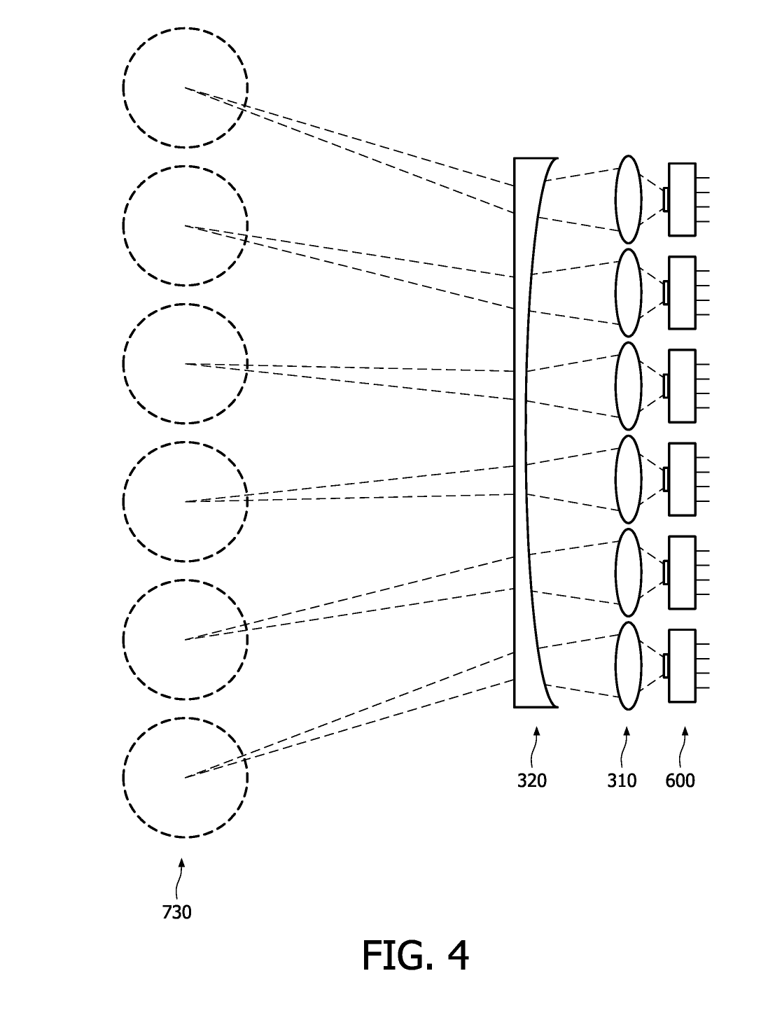

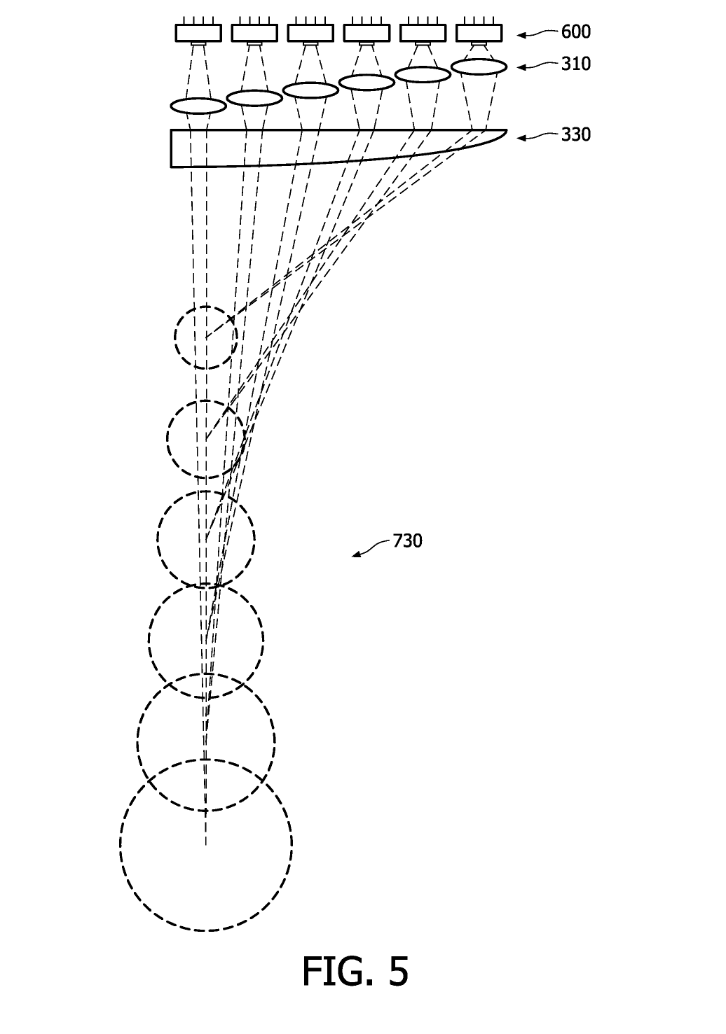

No specific movement is detected. Then the wobbling of the optics stops. The sensor field stays at position zo. The optical sensor is back again in its starting position.
A specific movement is detected or in other words the optical sensor detects a movement with a velocity component parallel to the measuring beam above a defined threshold value. In parallel, the amplitude of the signal of the specific movement or/and UT is used to optimize the position of the spatial position of the sensor field (with respect to maximum signal). This optimization of the position of the sensor field is done as long as a specific movement is detected. If there is no specific movement any longer, the wobbling is stopped. In the case there is a significant difference between the new position of the sensor field zl and that of zo, which was for example induced by a waggling hand that slowly (with respect to the waggling motion) moved its average position away from zo towards zl. The position zl is used as new starting position zo. The option to re-position the sensor field to a different starting position improves the flexibility of the optical sensor or a system comprising such an optical sensor. As an example, in the application of switching/dimming a lamp the sensor field may be shifted from close to the door to the sitting place by waggling the hand while going from the door towards the sitting place. After, for example, 1 hour without specific movement detection the starting position of the sensor field of the optical sensor may be reset to the original position zo close to the door. FIG. 4 shows a second embodiment of the invention. A system is shown with an optical sensor 600 comprising an array of lasers, detectors and filter devices, further comprising an optical device 300 consisting of first optical devices 310 (micro lenses) for focusing and second optical devices 320 (concave lens) directing the measuring beams of the different lasers to different directions in space. The individual measurement signals generated by the photodiodes can be processed individually. The photodiodes may be combined with different high-pass or bandpass filters which are characterized by different threshold values. The angular distribution of the sensor fields 730 may be used to add additional selectivity to a system comprising such an optical sensor. The system may be used, for example, to control the sound intensity of stereo equipment by e.g. addressing the different detectors of the optical sensor 600. Alternatively, the optical sensors may be combined with an optical device 300 comprising first optical devices 310 (micro lenses) for focusing and a third optical device 330 (convex lens) as shown in FIG. 5. The individual micro lenses may have different focal lengths and the convex lens is used for aligning the sensor fields 730. This will add additional depth information, i.e. approaching objects can be “traced”. These special embodiments provide the possibility of prescribing an expected movement by the design and/or programming of the electronics. For example, it may be demanded that a sensor at the edge reacts first, followed within a given time interval by the next, etc. This can be used to increase the discrimination against background or even to detect different movements (hand from left to right at a certain speed, etc.). The embodiments of a system according to the present invention shown in FIGS. 4 and 5 may only need two optical sensors, depending on the application.

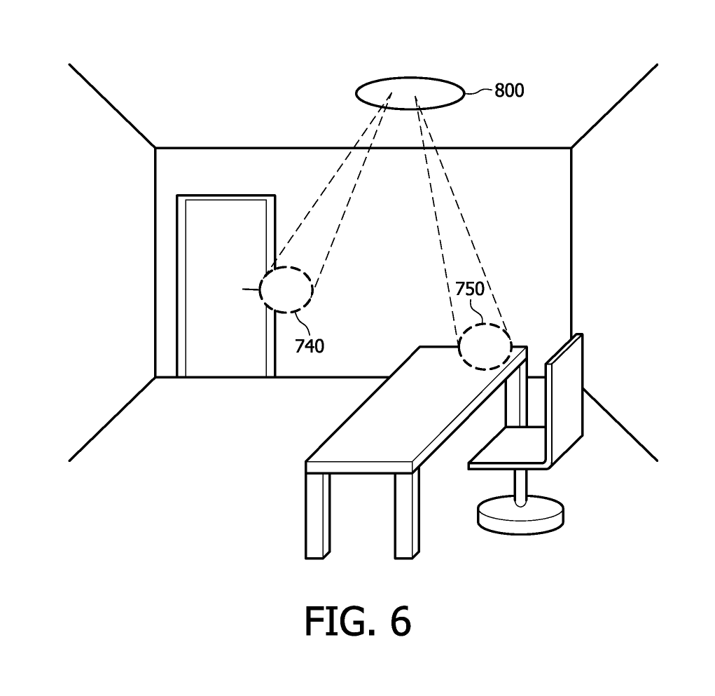

FIG. 6 is a schematic sketch of an optical sensor according to the invention, used in a system 800. The system 800 may be used for controlling and/or switching light in an office. The system may comprise two lasers generating two different sensor fields by means of an appropriate optical device. The first sensor field 740 is next to the door of the office in order to allow switching of the light when one or more persons approach or leave the office. The second sensor field 750 is next to the desk in order to allow switching of the light when a person sits at the desk. More advanced systems may comprise a plurality of optical sensors in order to generate different sensor fields, or one optical sensor comprising an array of lasers, detectors and filter devices. The sensor fields may be at different places in the office or, more generally, the room, or they may be at the same place but with different threshold values for the filter devices (preferably bandpass filters). The system may further comprise a detection system which is coupled to the optical sensor or optical sensors and can detect and/or locate moving objects in order to project the sensor fields next to the moving object. A person entering a room may be detected and the sensor field follows his movement by means of an adaptive optic or an array of optical sensors in order to allow switching of light from nearly every place in the room. Depending on the complexity of the system 800, the system may be extended to a home control system for remotely controlling further electric devices such as stereo equipment, TVs, a washing machine, a stove and the like.

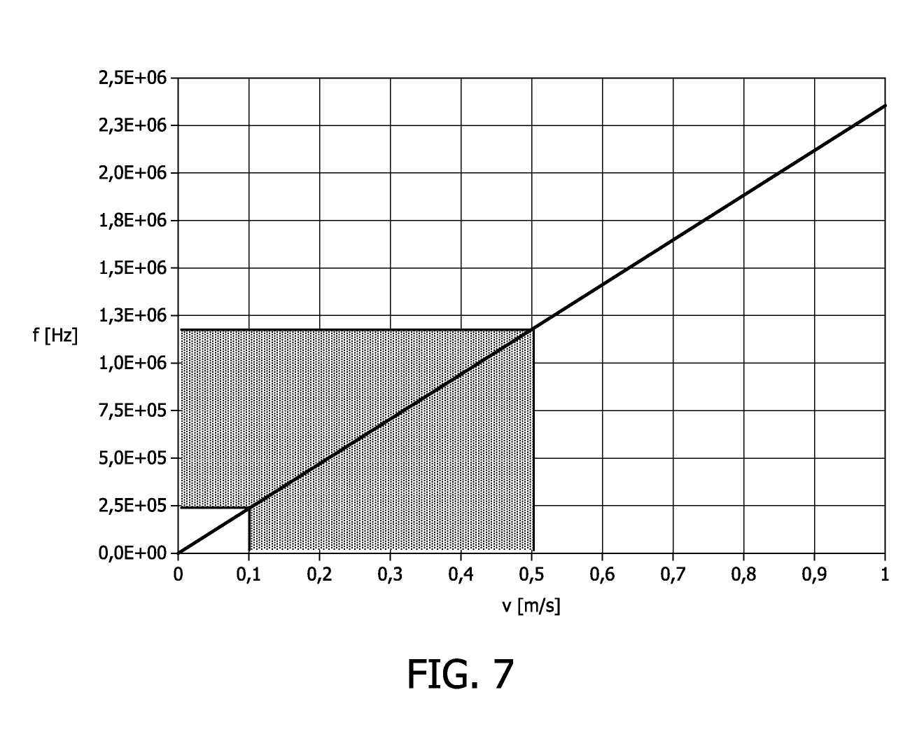

FIG. 7 shows the linear dependence between the velocity component of a moving object parallel to the measurement beam and the beat frequency of the interference signal in the laser cavity. The movement of a hand (the object) was measured with a VCSEL working at 850 nm. A velocity component of e.g. a hand parallel to the measurement beam of 0.1 m/s corresponds to a beat frequency of 0.25 MHz, and a velocity component of the hand parallel to the measurement beam of 0.5 m/s corresponds to a beat frequency of 1.25 MHz. The slope of the line depicting the linear dependence of the beat frequency on the velocity component parallel to the measurement beam is itself linearly dependent on the wavelength of the laser used for the measurement. As the laser has a shorter wavelength, the slope of the line is larger. The frequency range from 0.25 MHz to 1.25 MHz correlating with a velocity range from 0.1 m/s to 0.5 m/s as shown by the dark area in FIG. 7 may be used e.g. for switching light on or off. This means that the beat frequency in the laser cavity used in an embodiment of an optical sensor according to the invention may be converted into an electric signal by means of a photodiode. A subsequent bandpass filter suppresses all frequency signals below 0.25 MHz and above 1.25 MHz. The frequency signal passes the bandpass filter and the light is switched on or off only when the movement of a hand generates a frequency signal between 0.25 MHz and 1.25 MHz. A realistic velocity range of the movement of a human hand may be between 0.05 m/s and 5 m/s allowing use of a number of distinct velocity ranges or corresponding frequency ranges, e.g. for dimming a light source. Depending on the application, the velocity range may be different. Higher velocities may be of interest in, for example, industrial manufacturing applications.

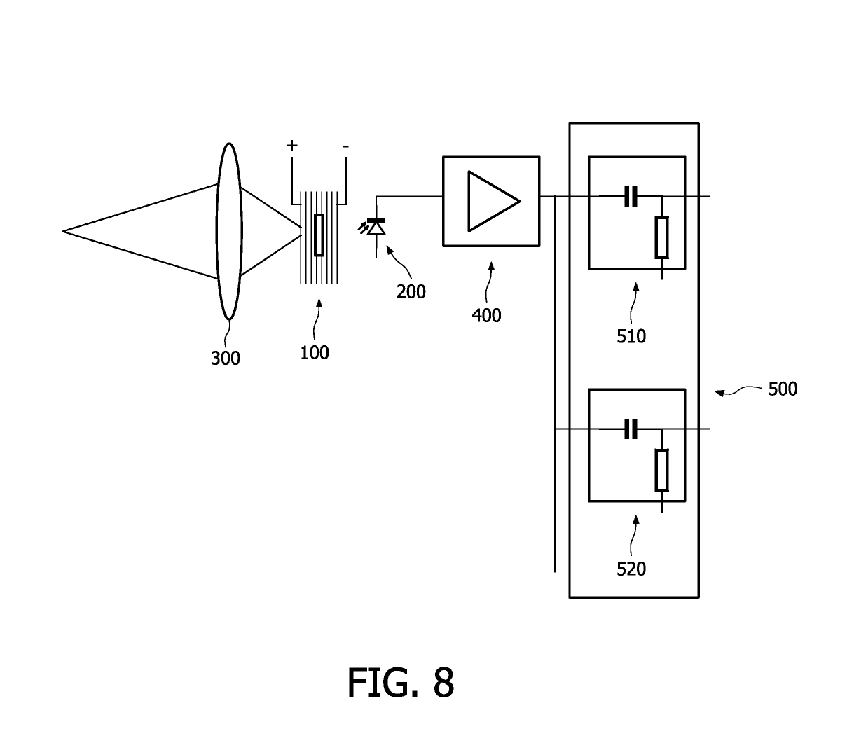

According to a further aspect of the present invention the performance of an optical sensor may be improved with respect to the demands of the application by performing a change of settings of the optical sensor from a certain defined distance (without special remote control). To switch between the “detection mode” for detecting an object with a velocity component parallel to the measuring beam above a defined threshold value and the “set mode” the optical sensor may be able to distinguish between normal feedback signals and strong feedback signals. Operating the detector in the strong feedback modus may activate the “set mode” of the optical sensor. This may be done, for example, by means of a reflecting element (like a rear reflector) moved in the sensitive spatial region of the optical sensor. Due to strong feed-back, besides the normally detected frequency component νo also higher harmonics 2 νo, 3 νo, . . . are generated in the optical sensor. FIG. 8 shows one possible embodiment to realize the switching from the “detection mode” to the “set mode”. In comparison to the embodiment of the invention shown in FIG. 2 a filter device with at least two high pass filters 510 and 520 is used. The first high pass filter 510 has a pass frequency below frequency νo in order to detect, for example, a waggling hand moving with a velocity component parallel to the measuring beam above a defined threshold value in the “detection mode”. The second high pass filter 510 has a pass frequency between frequency νo and the second harmonic 2 νo (preferably slightly below 2 νo). As soon as strong feedback is generated, for example, by means of a movement of a rear reflector with a velocity component parallel to the measuring beam above the defined threshold value a signal with a frequency of 2 νo passes the second filter 520 and a control circuit (not shown) switches the optical sensor in the “set mode” if the signal strength of the signal with a frequency of 2 νo is above a certain threshold value. After activation of the “set mode” new settings can now be applied. The sensor filed, for example, may be shifted by specific movements from first position to a second position. Or if variable high-pass filter with potentiometers are used instead of the filters 510 and 520 shown in FIG. 8, the threshold value of the defined velocity may be changed by changing the resistance of the potentiometers and therefore the pass frequency of the filters. The latter may be done, for example, by means of movement of a hand being related to a certain frequency that may be used to define the resistance of the potentiometer. For having the whole frequency range (and therefore velocity range) available the optical sensor may be first switched in a basic setting with a low threshold value of the velocity component parallel to the measuring beam. Another option to change the setting of the optical sensor may be the repetition of movements with a defined velocity component parallel to the measurement beam. The latter can be combined with defining the location of the sensor field if, for example, the repeated movements take place at a certain distance to the laser sensor and the laser sensor comprises means to adapt the location of the sensor field. The “set mode” may be also used to program a special sequence of movements that may be detected and identified by means of the optical sensor with a suitable control circuit. In the case the filter device comprises two, three or more bandpass filters instead of high-pass filters a sequence of movements with different velocities parallel to the measuring beam may be programmed. After the optical sensor is set back to the “detection mode” this sequence of movements may be used to trigger defined actions as, for example, switching a switch to open a door. Furthermore, a defined movement or a sequence of movements with different velocities parallel to measurement beam may be used to set the optical sensor in the “set mode” instead of using a strong feedback signal as described above. The optical sensor may be set back into the “detection mode” after, for example, 20 s, if no or no further movement is detected. Alternatively, the optical sensor may be set back into the “detection mode” by receiving a further strong feed-back signal or by means of a movement or sequence of movements with defined velocity components parallel to the measurement beam. The present invention has been described with reference to particular embodiments and certain drawings, but this is not to be construed in a limiting sense, as the invention is limited only by the appended claims. Any reference signs in the claims shall not be construed as limiting the scope thereof. The drawings described are only schematic and non-limiting. In the drawings, the size of some of the elements may be exaggerated and not drawn to scale for illustrative purposes. Where the verb “comprise” and its conjugations is used in the present description and claims, it does not exclude other elements or steps. Where an indefinite or definite article is used when referring to a singular noun, e.g. “a” or “an”, “the”, this includes a plural of that noun, unless specifically stated otherwise.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in sequences other than those described or illustrated herein.

Moreover, the terms top, bottom, first, second and the like in the description and the claims are used for descriptive purposes and not necessarily for describing relative positions. It is to be understood that the terms so used are interchangeable under appropriate circumstances and that the embodiments of the invention described herein are capable of operation in orientations other than those described or illustrated herein.

Other variations of the disclosed embodiments can be understood and effected by those skilled in the art in practicing the claimed invention, from a study of the drawings, the disclosure, and the appended claims.

1. A switch comprising an optical sensor for detecting the movement of an object relative to the position of the optical sensor, the optical sensor comprising at least one laser, at least one detector and at least one filter device, the laser having a laser cavity for generating a measuring beam and illuminating the object therewith, wherein at least some of the measuring beam radiation reflected by the object re-enters the laser cavity and causes interference of the reflected measuring beam radiation and the optical wave in the laser cavity, which interference of the reflected measuring beam radiation and the optical wave is influenced by the velocity of the movement of the object, the detector being adapted to sense the interference of the reflected measuring beam radiation and the optical wave and the detector is further adapted to generate a corresponding measurement signal, and the filter device is adapted to suppress measurement signals caused by movements of the object with a velocity component parallel to the measurement beam below 0.05 m/s.

2. (canceled)

3. The switch according to claim 1, wherein the filter device is adapted to suppress measurement signals caused by movements of the object at a velocity below a defined lower threshold value and to suppress measurement signals caused by movements of the object at a velocity above a defined higher threshold value.

4. The switch according to claim 3, comprising at least a first and a second laser, a first and a second detector and the filter device comprises a first and a second bandpass filter, the first bandpass filter being adapted to suppress measurement signals caused by movements of the object at a velocity below a defined first lower threshold value and to suppress measurement signals caused by movements of the object at a velocity above a defined first higher threshold value, and the second bandpass filter being adapted to suppress measurement signals caused by movements of the object at a velocity below a defined second lower threshold value and to suppress measurement signals caused by movements of the object at a velocity above a defined second higher threshold value.

5. The switch according to claim 4, wherein the first higher threshold value is lower than the second lower threshold value.

6. The switch according to claim 1, further comprising an optical device for shaping the measuring beam.

7. The switch according to claim 6, comprising at least a first laser for generating a first measuring beam and a second laser for generating a second measuring beam, the optical device being adapted to focus the first measuring beam to a first region in space and being further adapted to focus the second measuring beam to a second region in space.

8-10. (canceled)

11. A method of detecting the movement of an object relative to the position of a switch, wherein the switch comprises at least one laser having a laser cavity, at least one detector and at least one filter device being adapted to suppress measurement signals caused by movements of the object at a velocity below a defined threshold value, the method comprising the steps of:
generating a measuring beam in the laser cavity,
illuminating the object with the measuring beam,
reflecting a part of the measuring beam by the object,
re-entering the laser cavity of a part of the reflected measuring beam,
interfering of reflected measuring beam radiation and the optical wave in the laser cavity,
influencing the interference of the reflected measuring beam radiation and the optical wave by the velocity of the movement of the object,
sensing the interference of the reflected measuring beam radiation and the optical wave in the laser cavity by means of the detector,
generating a measurement signal by means of the detector, and
suppressing measurement signals caused by movements of the object with a velocity component parallel to the measurement beam below 0.05 m/s by means of the filter device, and
switching the switch if a measurement signal caused by movements of the object at a velocity with a velocity component parallel to the measurement beam above 0.05 m/s value is generated.

12. (canceled)
